(19) United States
(12) Patent Application Publication
(10) Pub. No.: US 2009/0087612 A1
(43) Pub. Date: Apr. 2, 2009

(54) Reflective Insulating Barriers In Floor Coverings

(76) Inventor: Robert Keith Salsman, Hoschton, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/243,516

(22) Filed: Oct. 1, 2008

Related U.S. Application Data
(60) Provisional application No. 60/976,656, filed on Oct. 1, 2007.

(51) Int. Cl. B32B 33/00; B32B 3/26

(52) U.S. Cl. 428/85; 428/319.1

(57) ABSTRACT

A reflective metallized material having at least one metal layer with at least one reflective surface that is capable of reflecting radiant energy, and at least one spacing layer to provide void space directly adjacent the reflective surface of the metal layer. The reflective metallized material may be used in a floor covering installation, such as in a carpet backing or carpet underlay, to provide a reflective insulating barrier to the floor covering. When the floor covering is installed, the resultant floor has improved energy efficiency.

### CROSS-REFERENCE TO RELATED APPLICATION

The present application claims priority to U.S. Provisional Application No. 60/976,656 filed Oct. 1, 2007, the contents of which are incorporated herein by reference in their entirety.

### BACKGROUND

1. Field of the Art

The embodiments described herein relate, in general, to floors and floor coverings having a thermal barrier. More particularly, the embodiments relate to floors or floor coverings, such as a carpet, having a layer of reflective metal foil, or other metallicized substrate to provide an insulating thermal barrier.

2. Description of Related Art

It is well known that polished metal surfaces reflect electromagnetic radiation. In fact, some polished foil surfaces can reflect more than 90% of infrared radiation. As an insulator, it has been shown that metallic materials, when properly used, can improve the efficiency of building materials, providing effective R-values of 50 or more. The R-value is a measure of thermal resistance, and is commonly used to characterize thermal insulation materials in buildings. In general, the higher the R-value, the greater the insulating effectiveness. By way of example, a fiberglass batt may have an R-value of about 3 (or “R-3”) per inch of thickness.

Because of these properties, reflective foil barriers have been introduced into building structures and insulation materials to improve their insulating properties. For example, U.S. Pat. No. 4,726,985, incorporated herein by referenced in its entirety, discloses the use of reflective foil barriers in attic insulation to reflect internal radiating energy, such as heat radiating up from a room below, or external radiating energy, such as from the sun. U.S. Pat. No. 5,134,831, incorporated herein by reference in its entirety, describes the use of a metallized layer wrap on the external walls of a building, such as under siding or roofing materials, to provide a convective and radiant energy barrier. Such uses of foil barriers improve the insulating properties of the building structure, and improve the energy efficiency by reducing the load on heating or air conditioning units.

In commercially available applications, the metallic component has been provided in several different forms, including foil sheets, metal chips, metal sheets laminated with layers of paper or plastic, and metal coatings on textiles or other substrates. For example, Radiant Technology Composites, of Irving, Tex., manufactures a double sided, polished aluminum foil for use as insulation.

In building structures, the most common applications for insulating materials are ceiling and wall insulation. Generally speaking, the floor of a commercial or residential building is not as well insulated as the rest of the building. One reason for this is that most of the heat loss or gain in a building structure occurs in the sides and ceiling of the house, which are more exposed to the elements. In addition, insulating the floor of a building can be quite difficult and expensive. For example, in a house with a crawl space the builder must pay for someone to install fiberglass insulation in the spans under the house to properly insulate it—a very difficult, expensive, and time consuming operation. Therefore, very little attention has been given to providing methods or materials for insulating floors.

In automobiles, a common focus for energy barriers is the windows. In the summer, temperatures inside an automobile can soar up to about 140° F. or more. Much of this is due to energy passing through the windows. The windows are transparent to infrared radiation, allowing the energy of the sun to pass through and be absorbed by interior structures. Researchers have developed reflective window glass panes that reflect at least some of this radiation. However, very little attention has been given to providing methods or materials for treating the remaining surfaces of the automobile enclosure to provide additional radiant energy barriers to improve the insulation of the enclosure.

The description herein of certain advantages and disadvantages of known processes, methods, and materials, is not intended to limit the scope of the embodiments. Indeed, the embodiments may include some or all of the processes, methods, and materials described above without suffering from the same disadvantages.

### SUMMARY

In view of the foregoing, the present embodiments provide materials and methods for insulating building and automobile enclosures. An object of the embodiments to provide materials and methods to improve the ease of installation of insulating materials in the floors of residential and commercial buildings, as well as the floors, walls, and ceilings of automobiles such as cars, buses, and RV's.

More particularly, the present embodiments provide materials and methods by which a reflective foil substrate is applied to a flooring material to reflect radiant energy within and outside of the enclosure.

These and other objects, features, and advantages will appear more fully from the following detailed description of the preferred embodiments when read in connection with the accompanying drawings.

### BRIEF DESCRIPTION OF THE DRAWINGS

FIG. 1 is a sectional view of a double sided metal layer, according to at least one embodiment;

FIG. 2 is a sectional view of a floor covering, according to at least one embodiment; and

FIG. 3 is a sectional view of a floor covering and a floor underlay, according to at least one embodiment.

### DETAILED DESCRIPTION OF PREFERRED EMBODIMENTS

Various embodiments described herein provide materials and methods of materials and methods for insulating building and automobile enclosures. More particularly, the present embodiments provide metallized reflective materials, such as a reflective foil substrate, that may be applied to a flooring material to reflect radiant energy within and outside of the enclosure. Other embodiments provide methods for using the metallized reflective materials to improve energy efficiency of a structure.

For purposes of clarity and illustration only, the materials and methods of the present embodiments are generally described herein in relation to carpeting materials. However, the materials and methods of the present embodiments may be used in conjunction with other flooring materials, now known or later developed, without departing from the spirit or scope of the embodiments. One of ordinary skill in the art, armed with the teachings provided herein, would be able to select such suitable materials for use with the present embodiments.

The inventors have found that adding a metallized reflective material to a flooring substrate, such as a carpet, may improve the insulation properties of the flooring substrate, and may improve the energy efficiency of the structure in which it is installed.

Preferably, the metallized reflective material may have at least one metal layer. The metal layer may include any material capable of reflecting radiant energy. Suitable metals include aluminum, cooper, chromium, nickel, gold, silver, steel, and the like, as well as combinations of these materials. For reasons of economy, the metal preferably is aluminum.

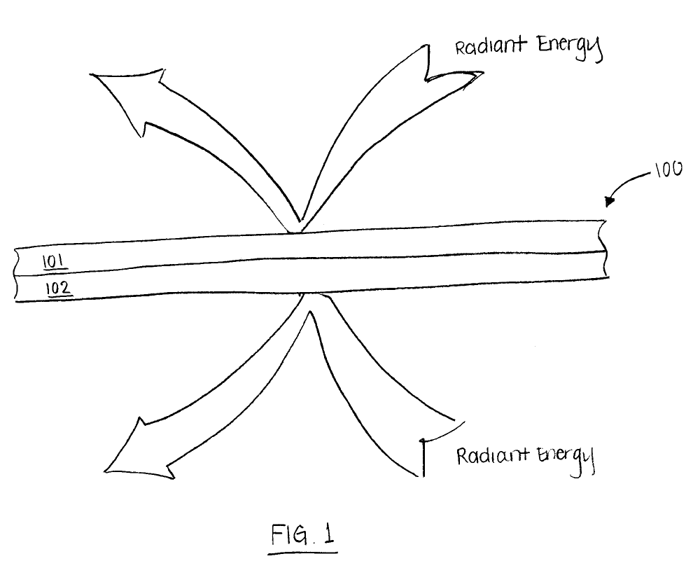

Preferably, the metal layer may be polished on at least one side. Without intending to be bound by a particular theory, it is believed that the more highly polished a layer of metal is, the higher its reflectivity, and the greater its ability to reflect radiant energy. Preferably, the metal layer may be double-sided, so that it may radiant energy from both surfaces. Even more preferably, the metal layer may be double-sided and polished on both sides. FIG. 1, illustrates a double-sided metal layer 100, having a first side 101 comprising a highly polished metal and a second side 102 comprising a highly polished metal. As shown in FIG. 1, radiant energy (illustrated with arrows) may be reflected from both sides 101 and 102 of the metal layer.

Preferably, the metal layer may be very thin. For example, a metal layer having a thickness of less than 1.0 mil is suitable for use herein. However, at such thickness, the metal layer may have very little structural integrity. Preferably, the metal layer may be supported by one or more additional substrates to provide a metallized material having suitable strength and flexibility for application to a flooring material. Preferably, the additional substrate may be provided as a sheet, layer, or coating that is applied to or laminated to the metal layer. The supporting substrate may be provided on one side of a metal layer, on both sides of a metal layer, or sandwiched between two metal layers.

Suitable supporting substrates may include sheets or films of polymers such as, for example, polyester, polycarbonate, polypropylene, polyethylene, polyamide, and cellophane. Other suitable substrates may include scrims, woven webs, nonwoven webs of polymer fibers. Other suitable substrates may include paper or another metal layer. Still other suitable substrates may include extruded hot melt polymers or adhesives, that may be applied to the metal layer as a continuous coating, intermittent coating, or fibers.

Preferably, the supporting substrate layer may be a flexible material such as a polyester or polyethylene. The thickness of the substrate layer can be, for example, on the order of 1.0 mil.

One of ordinary skill in the art would understand that if a metal layer contacts a source of energy, it will perform as an energy conductor rather than an insulator. Therefore, the metallized material preferably includes air or void space directly adjacent the one or more reflective surfaces of the metal layer to prevent the metal layer from directly contacting a source of energy. Preferably, one or more spacing substrates may be provided on the reflective surface of metal layer, providing air pockets or voids adjacent the one or more sides of the metal layer. For example, a hot melt polymer may be applied to one or both reflective surfaces of the metal layer in a specific striped, cross-hatched, or intermittent pattern that creates an air or void space adjacent the surfaces of the metal layer. As another example, a scrim material having sufficient open area and thickness may be laminated to one or both reflective surfaces of a metal layer to provide air or void space adjacent the surfaces of the metal layer. Alternatively, substrates having entrapped air (such as bubble wrap film, or certain foams) may be laminated to one or both of the reflective surfaces of the metal material, to provide air space adjacent the metal surface. For example, U.S. Pat. No. 5,100,725, the disclosure of which is incorporated herein by reference in its entirety, discloses a radiant heat barrier sandwiched between and bonded to two closed cell foam layers by non-heat conducting adhesive.

In various embodiments, a single substrate may be both a spacing substrate and a supporting substrate. Such a dual-purpose substrate may be strong enough to provide suitable strength to the metallized material, and may have a suitable structure to provide air pockets or spaces adjacent the metal layer. This dual-purpose substrate may be applied to one or both reflective surfaces of the metal layer.

The metal layer of the embodiments may be attached to the supporting substrate and the spacing substrate in any conventional laminating technique such as adhesive lamination, thermal lamination, mechanical lamination, and the like, or combinations thereof. Alternatively, the metal layer may be provided on the substrate layer by conventional metallizing techniques such as by vacuum metallizing, thermal or catalytic decomposition, electrolytic and electroforetic deposition, sputtering and ion deposition techniques. Once combined, the metallized material may be perforated or otherwise rendered pervious to vapors and liquid.

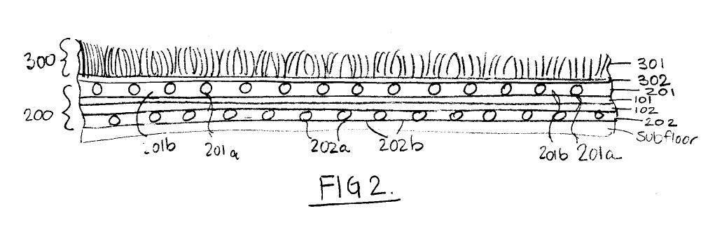

In various embodiments, the metal layer may be provided as part of a backing substrate for a carpet. With reference to FIG. 2, an exemplary embodiment of a carpet laminate 300 including a metallized material 200 will be described. Carpet laminate 300 may have a tufted carpet layer, including pile fibers 301 tufted at least partially through a backing material 302. Directly subjacent the carpet backing layer 302 is the metallized material 200. As shown in FIG. 2, the metallized material may comprise four layers: an upper dual-purpose spacing and supporting substrate 201, an upper metal layer 101, a lower metal layer 102, and a lower dual-purpose spacing and supporting substrate 202. The upper and lower dual purpose spacing and supporting substrates are shown in cross-section in FIG. 2. Substrates 201 and 202 may be provided in the form of a plurality of bands 201a and 202a, respectively, such as stripes or fibers of hot melt polymer. Adjacent bands 201a are spaced apart from each other to provide void spaces 201b between bands 201a. Adjacent bands 202a are spaced apart from each other to provide void spaces 202b between bands 202a. In addition, bands 201a may have sufficient height (or diameter) that a vertical space may be created between backing layer 301 and upper metal layer 101. Likewise, bands 202a may have a sufficient height (or diameter) to create a vertical space between the lower metal layer 102, and any surface subjacent to layer 202. This void space provided between adjacent bands and adjacent layers may provide sufficient air space to enable the adjacent metal layer 101 to reflect radiant energy.

As shown in FIG. 2, the metallized material 200 may be provided below carpet backing material 301 of tufted carpet 300. In conventional carpet manufacturing methods, carpeting yarns may be tufted into a primary backing material and then laminated with an adhesive to a secondary backing to hold the tufts in. In various embodiments, the metallized material can be incorporated into the secondary backing of the carpet material. For instance, a conventional secondary backing can be combined with or replaced with the metallized material that acts as the radiant barrier. Alternatively, the metallized material can be applied as an additional layer to a conventional secondary backing. In other embodiments, the metallized material may be incorporated into the primary backing of the carpet material, into which the carpet fibers are tufted.

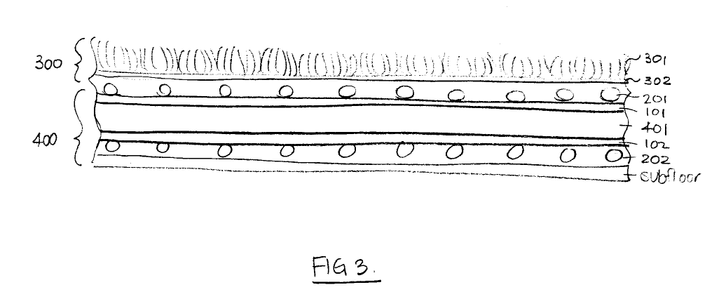

In other various embodiments, metallized material may be provided as part of a carpet underlay. In most conventional carpet installations, one or more underlay materials are provided between the subfloor, and the carpet. Underlay materials can be used to reduce noise and moisture, to provide a cushion to improve walking comfort, and to correct minor subfloor imperfections. Suitable underlay materials include felt or fiberous mats, cellular rubber or polymeric foams, loose materials such as crumb rubber, and various combinations thereof. With reference to FIG. 3, an exemplary embodiment in which the metallized material is provided as part of the carpet underlay 400 is described. In FIG. 3, carpet 300 is illustrated, having pile fibers 301 and a backing layer 302. Directly subjacent the carpet layer 300, is underlay 400, which includes the following layers: upper spacing layer 201, upper metal layer 101, central underlay layer 401, lower metal layer 102, and lower spacing layer 202. In this illustration, a metal layer and spacing layer are provided on both upper and lower surfaces if the underlay material 401. However, one of ordinary skill in the art would understand that the metal layer and spacing layer could be provided on just one surface, depending on the insulation needs.

By incorporating the metallized material into the carpet structure, the resultant carpet may be capable of reflecting radiant energy such as infrared radiation. When installed in a home or building, the metal-insulated carpet can improve the insulation properties of a floor. For example, in the winter the internal heat of a room is reflected back into the room and is not absorbed by or conducted through the flooring structure.

Preferably, the metallized layer may have sufficient strength and flexibility to be integrated into the carpet with no change in the physical aspect of the carpet.

Where the metallized material is incorporated into the primary, secondary, or additional (tertiary) backing layer of a carpet, the adhesive that bonds the carpet fibers, primary backing, and secondary backing materials together may be chosen such that it can bind to both the yarn tufts and the metal secondary or tertiary backing.

While the embodiments have been described with reference to particularly preferred embodiments and examples, those skilled in the art recognize that various modifications may be made thereto without departing from the spirit and scope thereof.

What is claimed is:

1. A metallized reflective floor insulation material comprising:
a metallized layer comprising
a first thin metal layer having at least a first reflective surface;
a first supporting substrate directly adjacent the metal layer, said first supporting substrate providing strength and flexibility to the metal layer;
a first spacing substrate directly adjacent the first reflective surface, said first spacing substrate having sufficient open area and height to provide void spaces over at least a portion of the adjacent first reflective surface of the metal layer;
a flooring layer having a first surface that is joined to a surface of the metallized layer.

2. The material recited in claim 1, wherein the metal layer has a second reflective surface, and wherein the metallized layer comprises a second spacing substrate directly adjacent the second reflective surface, said second spacing substrate having sufficient open area and height to provide void spaces over at least a portion of the adjacent second reflective surface of the metal layer.

3. The material recited in claim 1, wherein the flooring layer is a carpet.

4. The material recited in claim 3, wherein said carpet further comprises a pile fiber layer, and a backing layer, wherein said backing layer comprises said metallized layer.

5. The material recited in claim 3, further comprising a carpet underlay layer, wherein said carpet underlay layer comprises said metallized layer.

6. The material recited in claim 1, wherein the metallized layer further comprises:
a second thin metal layer having at least a first reflective surface;
a second spacing substrate directly adjacent the first reflective surface of the second metal layer, said second spacing substrate having sufficient open area and height to provide void spaces over at least a portion of the adjacent first reflective surface of the second metal layer.
